(19) United States
(12) Patent Application Publication
(10) Pub. No.: US 2022/0022720 A1
(43) Pub. Date: Jan. 27, 2022

(54) SURFACE CLEANING MACHINE COMPRISING A TANK DEVICE FOR DIRTY FLUID

(71) Applicant: Alfred Kärcher SE & Co. KG, Winnenden (DE)

(72) Inventors: Fabian Moser, Winnenden (DE); Michael Scharmacher, Winnenden (DE)

(21) Appl. No.: 17/494,442

(22) Filed: Oct. 5, 2021

Related U.S. Application Data
(63) Continuation of application No. PCT/EP2019/058844, filed on Apr. 8, 2019.

(51) Int. Cl. A47L 11/40; A47L 11/282; A47L 11/24; G01F 23/24

(52) U.S. Cl. CPC A47L 11/4019; A47L 11/282; A47L 11/24; A47L 11/4008; G01F 23/24; A47L 11/4075; A47L 11/4041; A47L 11/4083; A47L 11/4069

(57) ABSTRACT

The invention relates to a surface cleaning machine, including a cleaning head having at least one cleaning roller unit which is driven for rotary movement, and a tank device for dirty fluid, wherein a probe device is provided for determining a degree of fill of the tank device for dirty fluid.

### CROSS-REFERENCE TO RELATED APPLICATIONS

This application is a continuation of international application number PCT/EP2019/058844, filed on Apr. 8, 2019, which is incorporated herein by reference in its entirety and for all purposes.

### BACKGROUND OF THE INVENTION

The invention relates to a surface cleaning machine, comprising a cleaning head having at least one cleaning roller unit which is driven for rotary movement, and a tank device for dirty fluid.

Surface cleaning machines are known from patent applications WO 2016/058901 A1, WO 2016/058856 A1, WO 2017/063663 A1, WO 2016/058879 A1, WO 2016/058956 A1. Document WO 2016/058907 A1 likewise discloses a surface cleaning machine.

U.S. Pat. No. 4,875,246 discloses a portable floor cleaning apparatus which comprises a roller driven by an electric motor.

DE 20 2009 013 434 U1 discloses a wet floor cleaning apparatus comprising a brush which is rotatable about an axis of rotation.

CN 201 197 698 Y discloses a cleaning machine.

U.S. Pat. No. 6,026,529 discloses an apparatus for cleaning floors or other hard surfaces.

WO 2005/087075 A1 discloses a floor cleaning machine comprising a hand grip which is pivotally mounted on a base.

A further floor cleaning machine is known from WO 2015/086083 A1.

U.S. Pat. No. 3,789,449 discloses a hard floor cleaning device.

CN 107007215 A discloses a floor cleaning robot.

DE 20 2018 104 772 U1 discloses a dirty water collection mechanism and a dirty water detection mechanism and a cleaning apparatus.

### SUMMARY OF THE INVENTION

In an exemplary embodiment of the invention, a surface cleaning machine is provided which is simple and safe to operate.

In an exemplary embodiment of the invention, the surface cleaning machine comprises a cleaning head having at least one cleaning roller unit which is driven for rotary movement, and a tank device for dirty fluid; wherein a probe device is provided for determining a degree of fill of the tank device for dirty fluid.

By virtue of the probe device, it can be recognized whether the tank device for dirty fluid is filled with dirty fluid. This provides a way of preventing the surface cleaning machine from continued operation when a particular degree of fill of the tank device is reached, or of indicating to a user (in particular visually and/or audibly) that the tank device for dirty fluid is in need of emptying.

It is thereby possible to prevent overfilling of the tank device for dirty fluid and attendant unsatisfactory cleaning results: dirty fluid is prevented from overflowing the tank device with the attendant risk of recontaminating the surface being cleaned.

Furthermore, the emptying of the tank device by a user is facilitated because, in particular, the particular degree of fill is determined such that the tank device for dirty fluid can be easily emptied. In particular, it is also possible for the tank device for dirty fluid to be removed without allowing dirty fluid to spill out of the tank device as long as the particular degree of fill is not exceeded.

Furthermore, possible damage to a floor covering (as the surface to be cleaned) caused by liquid spilling out or forming puddles is prevented.

It is particularly advantageous for the probe device to be configured as a resistance measuring device. Such a probe device is simple to configure, control and evaluate. Use of a resistance measuring device provides a simple way of checking whether dirty fluid is present between probes of the probe device. This can be accomplished by measuring the current or resistance. If, for example, a particular degree of fill is reached and liquid (dirty fluid) is present between probes of the probe device, then a current can flow via the dirty fluid between the probes. This manifests itself in a change in resistance as compared with the case where no liquid is present between the probes. This change in resistance can be detected and is indicative of the reaching of a particular degree of fill. This particular degree of fill is in turn predetermined by the relative arrangement of the probes at the tank device. The probe device, when configured in the form of a resistance measuring device, can be implemented in a simple manner and at low cost. The corresponding probe device can be implemented with little vulnerability. The vulnerability to contact with dirt in the dirty fluid can also be kept low.

It is then advantageous for the probe device to be configured as an electrode device. In particular, the probes are then electrodes between which a voltage is applied or which have a current applied thereto. This provides a simple way of making a resistance determination, wherein a change in resistance is a measure of when a particular degree of fill is reached.

In an embodiment, the electrode device comprises at least one pair of electrodes comprising a first electrode and a second electrode in spaced relation to the first electrode, which electrodes project into a receiving space of the tank device for dirty fluid. The arrangement of the electrodes determines the particular degree of fill that is to be detected. Providing a plurality of electrode pairs which (in each case) comprise a first electrode and a second electrode and are arranged at different heights, opens up the possibility of determining different particular degrees of fill.

In an embodiment, the first electrode and the second electrode are fixedly connected to a holder for the tank device for dirty fluid, wherein the tank device for dirty fluid can be released from the holder. This provides a simple way of implementing a probe device that need not be configured for being releasable along with the tank device for dirty fluid. This makes for a structurally simple configuration.

Advantageously, provision is made for the electrode device to be arranged and configured such that a particular degree of fill of the tank device for dirty fluid can be detected. When electrodes of the electrode device project into the receiving space of the tank device at a particular height and pairs of electrodes are formed, then a particular degree of fill can be detected by the liquid level reaching between the electrodes of a pair of electrodes.

In an embodiment, provision is made for applying a direct current or a direct voltage to the electrode device. A basic signal is applied, and the degree of fill can then be determined from a reaction signal. In particular, a direct voltage is applied to electrodes of a pair of electrodes. When no liquid is present between the electrodes of the electrode pair, then no current can flow therebetween. The resistance can be taken as an idealized, infinite resistance. When liquid (dirty fluid) is present between the electrodes of a pair of electrodes, then a current can flow via the liquid. The resistance is thereby reduced. A corresponding reaction signal is thereby produced and can be determined. From the corresponding change in the reaction signal (associated, first, with an idealized, infinite resistance and, then, with a finite resistance), it can be detected whether a liquid level in the tank device for dirty fluid has reached the corresponding electrode pair.

It is advantageous for the probe device to be operatively connected to an evaluation device for signal communication therewith, in particular with at least one of the following:
the evaluation device controls an indication device and/or a transmitter;
the evaluation device initiates a warning signal for the indication device and/or the transmitter when the reaching of a particular degree of fill is detected;
the evaluation device checks a degree of fill of the tank device for dirty fluid via a resistance determination;
the evaluation device controls the probe device using, in particular, a direct current signal or a direct voltage signal;
the evaluation device comprises a filter device which checks for variations with time in the signals of the probe device, in particular wherein the filter device is configured such that temporary sloshing of dirty fluid in the tank device for dirty fluid can be recognized;
the evaluation device turns off drive to the at least one cleaning roller unit and/or transfer or transferability of cleaning liquid when a particular degree of fill is detected at the tank device for dirty fluid;
the evaluation device prevents rotary drive to the at least one cleaning roller and/or suction operation if, when starting operation of the surface cleaning machine, a particular degree of fill is detected.

By the evaluation device controlling an indication device, a degree of fill can be indicated to a user and, in particular, a warning signal can be emitted. When a transmitter is correspondingly controlled, a fill status of the tank device for dirty fluid can be indicated, for example, on a remote control device or a mobile device and, in particular, a warning signal can be emitted via this mobile device.

Preferably, the evaluation device checks the degree of fill of the tank device for dirty fluid via a resistance determination. Here it is preferably provided for the evaluation device to control the probe device utilizing, in particular, a direct current signal or a direct voltage signal. The evaluation device can then recognize the degree of fill via a corresponding reaction signal and can in particular recognize whether a particular degree of fill is reached.

Preferably the evaluation device comprises a filter device, and an electronic filter device in particular, which checks for variations with time in the signals of the probe device. It can thereby be recognized whether or not the tank device for dirty fluid experiences therewithin a relatively short-duration sloshing of dirty fluid. This provides a way of, in a sense, filtering out short-duration sloshing events in order to enable the degree of fill to be reliably determined. In particular, the evaluation device is configured such that operation of the surface cleaning machine is turned off when a particular degree of fill is detected for the tank device for dirty fluid, and/or such that starting operation of the surface cleaning machine is prevented when a corresponding condition is detected. In particular, overfilling of the tank device for dirty fluid is thereby prevented. Emptying of the tank device for dirty fluid can be accomplished in an ergonomic manner because a maximum fill level (the particular degree of fill) cannot be exceeded. Possible damage to a floor covering caused by dirty fluid spilling out or forming puddles is prevented.

It is advantageous for the indication device to be arranged at a hand grip via which the cleaning head can be guided by a user and/or for the indication device to be arranged at the cleaning head. A user can thereby easily recognize the fill status of the tank device for dirty fluid. A warning signal can be easily recognized by a user. In particular, a visual and/or audible signal is indicated on the indicator device.

In an embodiment, a first cleaning roller unit and a second roller unit in spaced relation to the first cleaning roller unit are provided, wherein the tank device for dirty fluid is positioned between the first cleaning roller unit and the second roller unit. Here, in particular, the cleaning head is supported via the first cleaning roller unit and the second roller unit on a surface that is to be cleaned. This provides a way of holding the position of the tank device for dirty fluid in a relatively stable position. The sloshing of dirty fluid in the tank device for dirty fluid is kept low.

In an embodiment, the second roller unit is a second cleaning roller unit or is a sweeping roller unit, in particular wherein provision is made for the first cleaning roller unit and the second roller unit to rotate in opposite directions. In principle, it is also possible for the second roller unit to be a pure supporting unit without a cleaning function.

In an embodiment, a cover wall is provided which is connected to the cleaning head and which covers the tank device for dirty fluid. This makes for a simple construction. In particular, the tank device for dirty fluid can then be inserted at the cleaning head from below or from the side, and can in particular be inserted between the first cleaning roller unit and the second roller unit.

It is then advantageous for electrodes of the probe device to be arranged at the cover wall, and in particular to be fixedly connected to the cleaning head. A probe device can thereby be implemented that need not be releasable along with the tank device for dirty fluid. For example, the cover wall itself then forms a cover for the tank device, or a further cover is provided for the tank device. The further cover is then provided with corresponding through-sockets for the electrodes.

It is then advantageous for electrodes of the probe device to project, in a direction transverse to a plane, from the cover wall into a receiving space of the tank device for dirty fluid, wherein a first axis of rotation of the first rotary roller unit and a second roller axis of the second roller unit lie in this plane. Said plane is in particular parallel to an envelope plane of the cover wall. This makes for simple construction. The electrodes can be fixedly positioned in place at the cleaning head.

In an alternative embodiment, the tank device for dirty fluid is releasably arranged at a holding rod device at which the cleaning head is arranged. The holding rod device serves in particular to enable a user to operate the surface cleaning machine in an upright posture, in particular wherein the user is then standing on a floor that is to be cleaned using the surface cleaning machine. In particular, the probe device is fixedly connected to the holding rod device if the tank device for dirty fluid is releasable. Releasing the tank device then means that the probe device need not be taken along with the tank device.

It is also possible for the surface cleaning machine in accordance with the invention to be configured as a self-propelled and self-steering apparatus, and to be configured as a cleaning robot in particular.

Furthermore, it is possible for the surface cleaning machine to be configured as a hand-guided apparatus which, in particular, comprises a holding rod device at which the cleaning head is arranged. In particular, the hand-guided apparatus is then operated by a user in an upright posture, standing on the surface to be cleaned, wherein the cleaning head having the at least one cleaning roller unit is supported on the surface to be cleaned.

Advantageously, a wetting device is provided by which the at least one cleaning roller unit and/or a surface to be cleaned can have cleaning liquid applied thereto, wherein the wetting device comprises a tank device for cleaning liquid. This provides enhanced loosening of the dirt.

Advantageously, provision is made for a flow-through region for cleaning liquid through which cleaning liquid which is provided by the tank device for cleaning liquid flows when it is fed to the at least one cleaning roller unit and/or to a surface to be cleaned.

Arranged at the flow-through region is a sensor device which determines the presence of cleaning liquid in the flow-through region.

By checking for the presence of cleaning liquid in the flow-through region, a determination can be made as to whether the tank device is empty (i.e., no longer contains cleaning liquid). When the tank device is emptied, there is also no cleaning liquid present in the flow-through region.

This provides a simple way of monitoring the emptying of the cleaning liquid tank device. Such checking can be performed from the exterior of the tank device. The tank device for cleaning liquid as well as the surface cleaning machine can thereby be configured with simple structure. No provisions need be made for the sensor device or a part of the sensor device to be removable from the surface cleaning machine.

By having the sensor device arranged at the flow-through region, the tank device for cleaning liquid can be checked independently of its position. Even sloshing of cleaning liquid in the tank device for cleaning liquid will have no effect on the checking that is done by the sensor device.

Making a determination as to whether the tank device for cleaning liquid is empty provides a simple way of preventing the surface cleaning machine from being operated without cleaning liquid. This provides a way of ensuring satisfactory cleaning results. Furthermore, potential damage to a surface covering (such as a floor covering) can be prevented by utilizing corresponding detection results of the sensor device in order for example to turn off the surface cleaning machine and, in particular, a rotary drive of the at least one cleaning roller unit.

It is advantageous for the flow-through region to be formed at a tube portion or a hose portion. The corresponding surface cleaning machine can thereby have a simple configuration.

In an embodiment, under the normally intended conditions of use of the surface cleaning machine, the flow-through region is arranged, relative to the direction of gravity, below the tank device for cleaning liquid. In particular, cleaning liquid can thereby be fed by a gravity-driven process, and in particular without pump assistance, from the tank device to the at least one cleaning roller unit and/or to the surface to be cleaned. In particular, no pump is required.

For the same reasons, it is advantageous if, relative to a flow direction of cleaning liquid, the flow-through region is arranged downstream of a port for the tank device for cleaning liquid. It is thereby possible to perform a detection check for the filling of the tank device for cleaning liquid (at least “digitally” with respect to cleaning liquid or empty tank device). Such check can be performed in a substantially position-independent manner, and the presence of sloshing of cleaning liquid in the tank device will have no effect on the measuring result.

In an embodiment configured with simple structure, a holder is provided at which the tank device for cleaning liquid is in particular releasably held in place. This provides a simple way of positioning the tank device for cleaning liquid at the surface cleaning machine, for example at a holding rod device or at the cleaning head.

Simple construction is achieved when a port for the tank device for cleaning liquid is arranged at the holder.

In particular, provision is made for a capability of the flow-through region to have liquid flowing therethrough to be coupled to a rotary drive of the at least one cleaning roller unit, and/or for the flow-through region to be located upstream of a valve device for transferring cleaning liquid to the at least one cleaning roller unit and/or to the surface to be cleaned. By way of example, when the surface cleaning machine is turned on, i.e., when the rotary drive is turned on, then by, for example, opening a valve device, cleaning liquid can be allowed to flow through the flow-through region in order to provide cleaning liquid to the at least one cleaning roller unit and/or to the surface that is to be cleaned. When the flow-through region is located upstream of the valve device, a measurement is still possible even when the valve device is blocked. For example, it can then be determined, prior to turning on a rotary drive, whether the tank device for cleaning liquid is sufficiently filled. If, for example, it is detected that no liquid is present in the flow-through region, then the surface cleaning machine, and hence a rotary drive, can be prevented from being brought into operation.

It is advantageous from a construction perspective for the flow-through region to be arranged at the holder. In particular, the flow-through region is configured as a tube or hose located at the holder.

In an embodiment configured with simple structure, the sensor device is configured as a resistance measuring device. In particular, it is then possible for a check to be made as to whether a first resistance condition of high resistance or a second resistance condition of low resistance, relative to the high resistance, is present. The first resistance condition is indicative of a flow-through region in which no liquid is present. The second resistance condition characterizes a flow-through region in which liquid is present. This, in turn, allows the degree of fill of the tank device for cleaning liquid to be inferred; it can at least be said that no more cleaning liquid is present in the tank device for cleaning liquid or that cleaning liquid is still present.

In an embodiment configured with simple structure, provision is made for a direct current or a direct voltage to be applied to the electrode device. A resistance determination can then be made, at least indirectly, via a reaction signal which is, in particular, a voltage signal or a current signal.

It is advantageous from a construction perspective for the sensor device to comprise a first electrode and a second electrode in spaced relation to the first electrode, wherein the first electrode and the second electrode project into the flow-through region. An electrical resistance occurring between the first electrode and the second electrode depends on whether or not liquid is present between the first electrode and the second electrode. If cleaning liquid is present between the first electrode and the second electrode, the resulting resistance is low. If no liquid is present between the first electrode and the second electrode, the resulting resistance is high, and this resistance can be taken as an idealized, infinite resistance. It is thus possible to determine, from a resistance determination, whether or not liquid is present.

In particular, the first electrode and the second electrode are located in a wall of the flow-through region, and are in particular injection molded thereinto. This provides a simple way of forming a fluid-tight flow-through region with integrated sensor device.

It is advantageous from a construction perspective for the first electrode and/or the second electrode to be formed as metal pins.

It is particularly advantageous if it can be determined via the sensor device whether the tank device for cleaning liquid is empty, the emptying of the tank device for cleaning liquid being inferred from the absence of cleaning liquid in the flow-through region. The corresponding check can thereby be performed from the exterior of the tank device for cleaning liquid. This provides a simple way of configuring the tank device for cleaning liquid for removability. The check can be performed in a substantially position-independent manner. Sloshing of cleaning liquid in the tank device will have substantially no effect on the result of the check.

It is advantageous for the sensor device to be operatively connected to an evaluation device for signal communication therewith, in particular wherein provision is made for at least one of the following:
the evaluation device determines a degree of fill of the tank device for cleaning liquid from sensor data of the sensor device;
the evaluation device controls the sensor device;
the evaluation device is operatively connected to an indication device and/or a transmitter, for signal communication therewith;
the evaluation device initiates a warning signal when the tank device for cleaning liquid is detected as being empty;
the evaluation device turns off a rotary drive for the at least one cleaning roller unit when the tank device for cleaning liquid is detected as being empty;
the evaluation device prevents a rotary drive for the at least one cleaning roller from being turned on if, when starting operation of the surface cleaning machine, the tank device for cleaning liquid is detected as being empty.

The evaluation device provides, for example, an application signal for the sensor device, which signal is a direct voltage signal by way of example. It then determines, in particular, a reaction signal from which a liquid filling of the flow-through region can be inferred.

By the indication device, a user can be provided with an indication as to whether or not the tank device is empty, and, for example, a warning signal can be emitted. By the operative connection of the evaluation device to a transmitter for signal communication therewith, corresponding indicator signals or also warning signals can be transmitted, for example, to a remote control or a mobile device, such as a smartphone.

It is advantageous for the indication device to be arranged at a hand grip via which the cleaning head can be guided by a user, and/or to be arranged at the cleaning head. This provides a simple way for a user to recognize what the condition of the tank device for cleaning liquid is. For example, a visual and/or audible warning signal is emitted via the indication device.

The following description of preferred embodiments serves in conjunction with the drawings to explain the invention in greater detail.

### BRIEF DESCRIPTION OF THE DRAWINGS

FIG. 1 illustrates, in a perspective view, a first exemplary embodiment of a surface cleaning machine in accordance with the invention;

FIG. 2 shows a partial sectional view in the cutting plane E of the surface cleaning machine in accordance with FIG. 1;

FIG. 3 shows an enlarged view of detail A of FIG. 2;

FIG. 4 illustrates, in a perspective view, a second exemplary embodiment of a surface cleaning machine in accordance with the invention;

FIG. 5 shows an enlarged view of a cleaning head of the surface cleaning machine in accordance with FIG. 4;

FIG. 6 shows a sectional view of the cleaning head in accordance with FIG. 5;

FIG. 7 shows a bottom view of the cleaning head in accordance with FIG. 5, wherein the tank device for dirty fluid has been removed;

FIG. 8 shows a schematic sectional view of a third exemplary embodiment of a surface cleaning machine in accordance with the invention; and

FIG. 9 shows a schematic representation of an evaluation device comprising a probe device for determining whether a tank device for cleaning liquid is empty, and comprising a sensor device for determining a degree of fill of a tank device for dirty fluid.

### DETAILED DESCRIPTION OF THE INVENTION

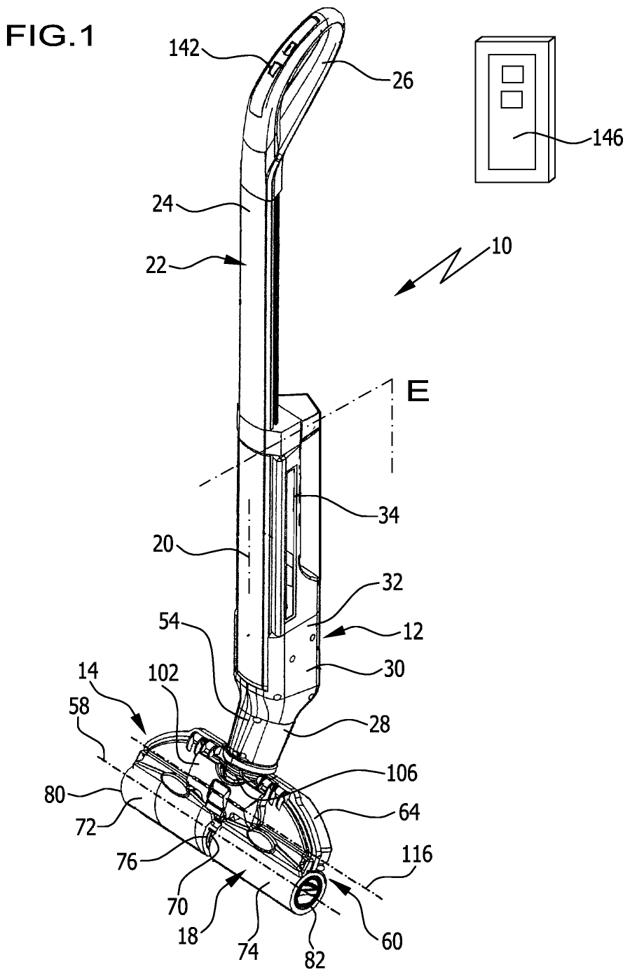

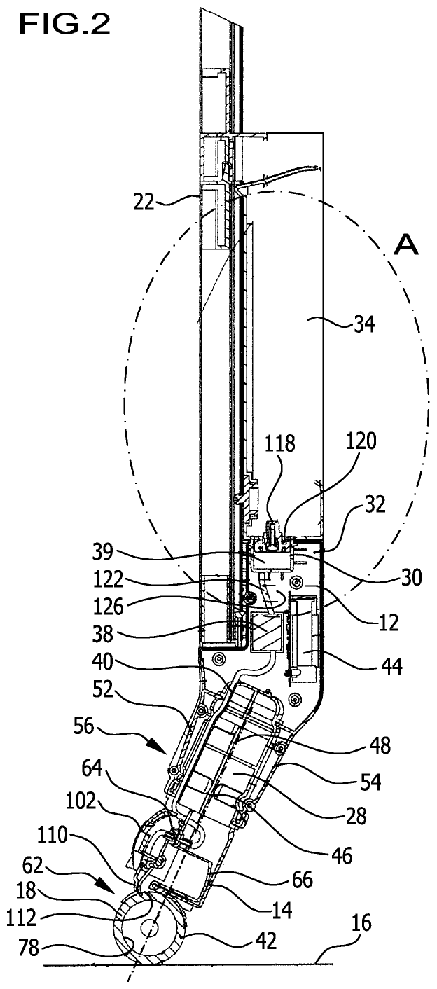

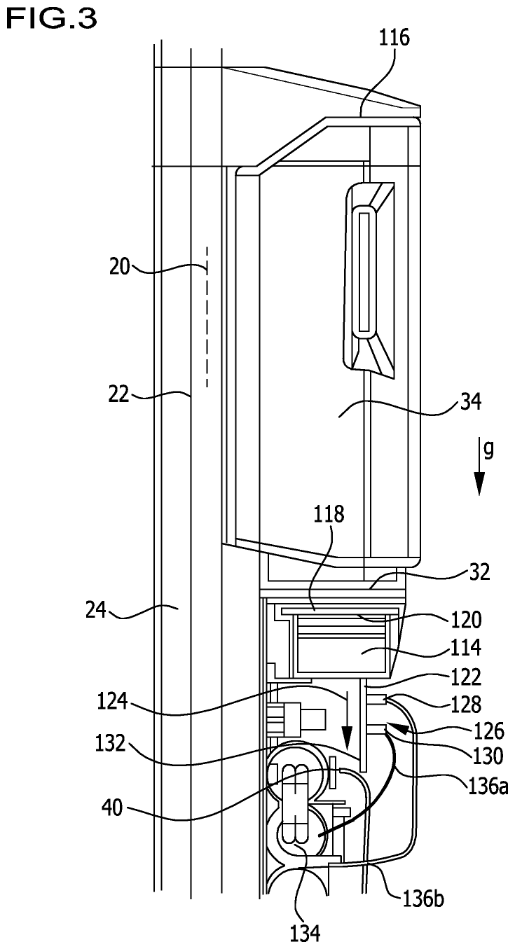

A first exemplary embodiment of a surface cleaning machine in accordance with the invention, shown in FIG. 1 and in the partial views of FIGS. 2, 3 and designated therein by 10, is in particular configured in the form of a hand-held and hand-guided floor cleaning machine for hard-surfaced floors.

The surface cleaning machine 10 comprises an apparatus body 12 and a cleaning head 14. The cleaning head 14 is arranged at the apparatus body 12.

In a cleaning operation that is performed on a surface 16 to be cleaned, the surface cleaning machine 10 is supported on the surface 16 to be cleaned via a cleaning roller unit 18, and in particular a single cleaning roller unit 18. The cleaning roller unit 18 has a single axis of rotation (see below). The cleaning roller unit 18 is a cleaning roller that can be of one-part or multi-part construction. In the embodiment as discussed in the following, the cleaning roller unit 18 is a two-part cleaning roller.

The apparatus body 12 has a longitudinal axis 20. The surface cleaning machine 10 is handle-held, or handle-guided. To this end, a holding rod device 22 is located at the apparatus body 12.

In an exemplary embodiment, the holding rod device 22 comprises a holding rod 24 (in particular, exactly one holding rod 24) which has a longitudinal extension in a direction parallel to the longitudinal axis 20. A (hand) grip 26, and in particular a loop-type grip, is arranged in an upper portion of the holding rod device 22. A user can hold the surface cleaning machine 10 with one hand by the grip 26 and guide it over the surface 16 to be cleaned (with the cleaning roller unit 18 supported on the surface 16).

The holding rod device 22, relative to a length in the longitudinal axis 20, can be of variable-length configuration or of fixed-length configuration.

The dimensions of the surface cleaning machine 10 are configured such that, with the cleaning roller unit 18 being supported on the surface 16 to be cleaned, a user is enabled to comfortably carry out a cleaning operation on the surface 16 being cleaned with a bent arm. In particular, a length of the surface cleaning machine 10 along the longitudinal axis 20 between the cleaning roller unit 18 and the loop-type grip 26 is in a range of between 60 cm and 130 cm.

In particular, one or more control elements and indicator elements (see below) are arranged at the grip 26. For example, a switch is arranged by which operation of the surface cleaning machine 10 for cleaning action can be turned on or off. Operation of this switch activates or deactivates operation of a drive motor 28 for rotary action of the cleaning roller unit 18. Furthermore, a switch can be provided for actuating a valve device 38 (see below).

The apparatus body 12 comprises a housing 30 in which components of the surface cleaning machine 10 are accommodated and thereby protected.

Arranged at the housing 30 is a holder 32. Removably arranged at the holder 32 is a tank device 34 for cleaning liquid (comprising, in particular, fresh water with or without added cleaning agent).

In an embodiment the tank device 34 comprises a single tank comprising, in particular, a single chamber for holding cleaning liquid.

A valve device 38 is positioned in the housing 30.

One or more fluid conduits 40 are routed from the valve device 38 to the cleaning head 14.

The valve device 38 comprises a shut-off valve via which it is switchable whether the supply of cleaning liquid from the tank device 34 to the cleaning head 14 is blocked or unblocked. The valve device 38 can have associated therewith a filter device 39. In particular, the filter device 39 is arranged upstream of the shut-off valve and between the valve device 38 and a tank receptacle.

When the shut-off valve is open, cleaning liquid is allowed to flow from the tank device 34, through the fluid conduit(s) 40 and to the cleaning head 14 and can be applied to the surface 16 that is to be cleaned.

To this end, one or more outlet mouths for cleaning liquid are provided in the cleaning head 14. In principle, it is thereby possible for the outlet mouth(s) to be arranged such that the surface 16 to be cleaned has the cleaning liquid applied thereto directly.

In an advantageous variant, the outlet mouth(s) are arranged such that the cleaning liquid is applied to the cleaning roller unit 18, and in particular to a cleaning substrate 42 of the cleaning roller unit 18. When the cleaning liquid is applied to the cleaning roller unit 18, the surface 16 to be cleaned then has the cleaning liquid applied thereto indirectly.

The cleaning substrate 42 is made of a textile material in particular.

Associated with the valve device 38 is a switch by way of which the user can adjust whether the shut-off valve of the valve device 38 is blocked (i.e., the flow of cleaning liquid to the cleaning head 14 is inhibited), or whether the shut-off valve is open (i.e., the flow of cleaning liquid from the tank device 34 to the cleaning head 14 is permitted).

This switch can be arranged at the housing 30. In principle, it is also possible for the switch to be arranged at the grip 26.

In an exemplary embodiment, a battery device 44 for the supply of electrical energy to the drive motor 28 is arranged in the housing 30. The battery device 44 is rechargeable. The surface cleaning machine 10 can thereby be operated independently of a mains grid supply of electricity.

In principle however, it is also possible for the surface cleaning machine 10 to be operated using electricity from the mains grid supply. A corresponding terminal device for connection to mains current is then arranged on the surface cleaning machine 10.

Here, the battery device 44 can be removable from the apparatus body 12, allowing recharging to be effected at a corresponding charging device.

Provision may also be made for a corresponding charging device to be integrated into the apparatus body 12 and for a recharging operation to be performable without separating the battery device 44 from the apparatus body 12. Corresponding connection sockets are arranged at the holding rod 24 by way of example.

The drive motor 28 is an electric motor. It comprises a motor axis 46. The motor axis 46 is coaxial with an axis of rotation of the drive motor 28.

The drive motor 28 is located between the cleaning head 14 and the housing 30 at the apparatus body 12.

In an exemplary embodiment, the motor axis 46 is oriented at an angle to the longitudinal axis 20 of the apparatus body 12 (and of the holding rod 24). The angle between the motor axis 46 and the longitudinal axis 20 is in a range of between 150° and 170°, for example.

In an exemplary embodiment, the cleaning head 14 is mounted for pivotal movement about a pivot axis 48.

In particular, the pivot axis 48 is coaxial with the motor axis 46.

In an embodiment, the drive motor 28 is arranged at an inner sleeve 52. The inner sleeve 52 preferably forms an enclosure for the drive motor 28.

An outer sleeve 54 is fixedly located at the apparatus body 12. The inner sleeve 52 is located in the outer sleeve 54. Here, the inner sleeve 52 is mounted for pivotal movement about the pivot axis 48 relative to the outer sleeve 54, the inner sleeve 52 being supported for pivotal movement in the outer sleeve 54. The inner sleeve 52 and the outer sleeve 54 form a pivot bearing 56 to provide the pivotability of the cleaning head 14 relative to the apparatus body 12. Here, the drive motor 28 is pivotable about the pivot axis 48 relative to the apparatus body 12. Corresponding electrical leads from the battery device 44 to the drive motor 28 are arranged and configured such that they permit the pivotability. Correspondingly, the one or more fluid conduits 40 are configured such that they permit said pivotability.

The pivot bearing 56 has a basic position which, for example, is defined in that a (the only) axis of rotation 58 of the cleaning roller unit 18 is oriented perpendicularly to the plane E in accordance with FIG. 1. A pivotal movement about the pivot axis 58 relative to said basic position manifests itself as an angular position of the axis of rotation 58 relative to the plane E.

In particular, the pivot bearing 56 is adjusted in such a manner that, relative to a normal cleaning operation, a particular expenditure of force needs to be effected in order to enable the cleaning head 14 to pivot out of its basic position.

Providing the cleaning head 14 with the capability of pivoting about the pivot axis 48 provides enhanced cleaning capabilities even in hard-to-reach places in that, in a sense, the apparatus body 12 can be “re-located” relative to the surface 16 to be cleaned by way of the holding rod device 22.

The cleaning head 14 comprises a cleaning roller holder 60 at which the cleaning roller unit 18 is located for rotary movement about the axis of rotation 58. The cleaning roller holder 60 is coupled in rotationally fixed relation to the inner sleeve 52.

The cleaning roller holder 60 comprises a holding region 62 for the cleaning roller unit 18, and a receiving chamber 64 for a tank device 66 for dirty fluid.

The receiving chamber 64 is positioned between the holding region 62 and the inner sleeve 52. In particular, the inner sleeve 52 is fixedly connected to an outer side of the receiving chamber 64.

The cleaning roller unit 18 is operatively coupled to the drive motor 28 via a gear device for torque transmission therebetween.

The gear device operatively couples a motor shaft of the drive motor 28 (which rotates about the motor axis 46) to a shaft 70 of the cleaning roller unit 18 for torque transmission therebetween.

In an exemplary embodiment, the gear device comprises a speed reducer. The speed reducer serves for reducing a rotational speed relative to the rotational speed of the motor shaft. For example, a standard electric motor has rotational speeds that are of the order of magnitude of 7,000 revolutions per minute. The speed reducer provides speed reduction down to about 400 revolutions per minute for example.

The speed reducer can be arranged in the inner sleeve 52, or it can be arranged outside of the inner sleeve 52, at the cleaning roller holder 60.

The speed reducer is configured in the form of a planetary gear for example.

Furthermore, the gear device comprises an angular gear which provides for redirecting torque to effect drive of the cleaning roller unit 18 with the axis of rotation 58 transverse (and in particular perpendicular) to the motor axis 46. In particular, the angular gear is located downstream of the speed reducer.

In an exemplary embodiment, the angular gear comprises one or more gear wheels which are coupled to a corresponding shaft of the speed reducer in rotationally fixed relation thereto. These act upon a bevel gear for changing the angle.

The gear device in an exemplary embodiment further comprises a belt which is coupled to the angular gear for torque transmission therebetween and acts upon the shaft 70. The belt spans the distance between the shaft 70 and the angular gear and provides speed reduction.

In an exemplary embodiment, the cleaning roller unit 18 is of two-part configuration comprising a first part 72 and a second part 74. The first part 72 is located on a first side of the shaft 70 in rotationally fixed relation thereto, and the second part 74 is located on a second side, opposite the first side, of the shaft 70 in rotationally fixed relation thereto.

Guidance of the gear device and coupling thereof to the shaft 70 is provided in an intermediate region 76 between the first part 72 and the second part 74. The two parts have the same axis of rotation 58.

The cleaning roller unit 18, or the first part 72 and the second part 74 of the cleaning roller unit 18, comprise a sleeve 78 which is of cylindrical configuration. The cleaning substrate 42 is arranged on the sleeve 78. The cleaning roller unit 18, or the first part 72 and the second part 74 thereof, is or are fixed to the shaft 70 via the sleeve 78.

The cleaning roller unit 18 is arranged at the cleaning head 14 such that the axis of rotation 58 is oriented perpendicularly to the longitudinal axis 20.

Along the axis of rotation 58, between a first end face 80 (which is formed on the first part 72) and a second end face 82 (which is formed on the second part 74), the cleaning roller unit 18 has a length that is considerably greater than a corresponding width of the apparatus body 12 perpendicular to the longitudinal axis 20. In particular, a length of the cleaning roller unit 18 between the first end face 80 and the second end face 82 is at least 20 cm and preferably at least 25 cm.

The receiving chamber 64 comprises a bottom. Arranged at the bottom, oriented transversely thereto, is a receiving chamber wall. The receiving chamber wall and the bottom of the receiving chamber 64 define a receiving space for the tank device 66 for dirty fluid.

The receiving space is open opposite the bottom. The dirty fluid tank device 66 can be removed from the receiving space and inserted thereinto via a corresponding side. A removal or insertion direction is substantially perpendicular to the bottom (and perpendicular to the axis of rotation 58).

Associated with the receiving chamber 64 is a fixing device via which the tank device 66 for dirty fluid can be fixed to the receiving chamber wall in a holding position. In particular, the fixation is by form-locking engagement.

In an embodiment, the fixing device 98 comprises a flap 102 which is mounted to the cleaning head 14 for pivotal movement about a pivot axis by a pivot bearing 106. Here, the pivot bearing 106 is positioned at or proximate the inner sleeve 52.

The pivot axis is oriented parallel to the axis of rotation 58 of the rotary roller 18. In the holding position, the flap 102 acts on the tank device 66 for dirty fluid and holds same at the receiving chamber 64 in the receiving space.

For removal of the tank device 66 from the cleaning head 14, the flap 102 is pivotable starting from said holding position in a direction of the apparatus body 12 in order to release the tank device 66 so that the tank device 66 can be taken out of the receiving space from the side in the removal direction and can be removed from the cleaning head 14.

For further details with respect to the configuration of the surface cleaning machine 10, reference is made to WO 2017/153450 A1. This document is incorporated herein and made a part hereof by reference in its entirety and for all purposes.

The cleaning head 14 comprises a scraper/guide device 110 which acts on the cleaning roller unit 18 (and, hence, on the first part 72 and the second part 74) and serves to loosen dirty fluid (in particular water carrying dirt particles) picked up by the cleaning roller unit 18 and feed it to an inlet mouth 112 of the tank device 66 for dirty fluid. Dirty fluid is then thereby incoupled into the dirty fluid tank device 66.

The scraper/guide device 110 is configured such that it scrapes dirty fluid off the cleaning roller unit 18 and directs the dirty fluid into the inlet mouth 112.

It is thereby possible that, while the cleaning roller unit 18 is being rotated, a guide effect is achieved via the effect of centrifugal force, whereby dirty fluid is, in a sense, thrown into the dirty fluid tank device 66.

The scraper/guide device 110 is in spaced-apart relation to the axis of rotation 58.

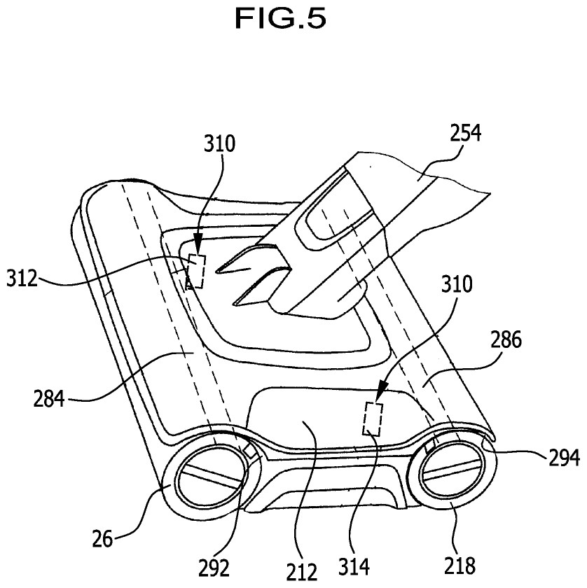

In an embodiment (cf. FIG. 5 for example), the scraper/guide device 110 projects into the cleaning substrate 42 of the cleaning roller unit 18 to a depth T. In particular, the depth T amounts to at least 5% of a thickness D of the cleaning substrate 42 of the cleaning roller unit 18, relative to a wetted condition of the cleaning substrate 42.

In particular, the scraper/guide device 110 is formed by one or more edge elements. For example, a respective edge element is associated with the first part 72 and the second part 74 of the cleaning roller unit 18.

For further details with respect to the configuration of the surface cleaning machine 10, reference is made to WO 2017/153450 A1. This document is incorporated herein and made a part hereof by reference in its entirety and for all purposes.

The holder 32 for the tank device 34 for cleaning liquid comprises a transverse region 114 (cf. FIG. 3) which projects transversely from the holding rod 24 with respect to the longitudinal axis 20. The tank device 34 can be placed onto said transverse region 114 and can be fixed to the transverse region 114, it being possible to provide for additional fixation thereof to the holding rod 24. In an exemplary embodiment, the tank device 34 is configured such that the tank device 34 can be clamped between the transverse region 114 and a spaced-apart retaining bar 116.

The tank device 34 for cleaning liquid comprises an outlet 118.

Arranged at the transverse region 114 is a port 120 for the tank device 34. The port 120 can be operatively connected to the outlet 118 for fluid communication therewith so that cleaning liquid can be incoupled into the apparatus via the port 120. The port 120 is operatively connected to the fluid conduit 40 for fluid communication therewith via a flow-through region 122, or the flow-through region 122 can be considered part of the fluid conduit 40.

The flow-through region 122, relative to a flow direction 124 for cleaning liquid which flows from the tank device 34 into the conduit 40, is located downstream of the tank device 34 for cleaning liquid and is here also located downstream of the port 120.

In particular, the flow-through region 122 is formed by a tube portion which is integrated into the holder 32, and here into the transverse region 114 of the holder 32 or arranged thereat. In particular, the flow-through region 122 is in direct operative fluid communication with the port 120. The port 120 forms an inlet of the flow-through region 122.

In particular, the tube portion is configured as a rigid tube portion.

Arranged at the flow-through region is a sensor device 126 which checks whether liquid (cleaning liquid) is present in the flow-through region 122. If no cleaning liquid is present in the flow-through region 122, then this means that the tank device 34 for cleaning liquid is empty. Via the presence of cleaning liquid in the flow-through region 122, the fill status, with cleaning liquid, of the tank device 34 for cleaning liquid can be determined, i.e., it can be detected in particular whether the tank device 34 is empty.

In particular, provision is made for the flow-through region 122 to be located upstream of the valve device 38 with respect to the flow direction 124 for cleaning liquid.

In particular, provision is made that, in operation of the surface cleaning machine 10, cleaning liquid is fed to the cleaning roller unit 18 by a gravity-driven process. In particular, no pump is provided that transports cleaning liquid.

In an embodiment, the flow-through region 122 is formed downstream of the filter device 39. However, it may also be provided for the flow-through region 122 to be located upstream of the filter device 39.

The sensor device 126 is configured as a resistance measuring device in particular. It is configured as an electrode device. To this end, it comprises a first electrode 128 and a second electrode 130. The first electrode 128 and the second electrode 130 are spaced apart from one another. They project into the flow-through region 122, wherein (if cleaning liquid is present in the flow-through region 122) they are immersed in the cleaning liquid.

In an exemplary embodiment, the flow-through region 122 comprises a wall 132, wherein the first electrode 128 and the second electrode 130 are arranged at the wall 132, and are arranged in particular in the wall.

In an embodiment, the first electrode 128 and the second electrode 130 are formed as metal pins. In particular, the first electrode 128 and the second electrode 130 are injection molded or insert molded into the wall. As a result, a fluid-tight seal of the flow-through region 122 is achieved at the first electrode 128 and the second electrode 130.

The first electrode 128 and the second electrode 130 are connected to an evaluation device 134. For example, provision is made for such connection to be made via lines 136a, 136b respectively.

In principle, the evaluation device 134 cooperates with the sensor device 126 as follows:

A voltage, and in particular a direct voltage, is applied between the first electrode 128 and the second electrode 130. Here the direct voltage can be a permanently applied voltage or it can be a pulsed voltage.

When liquid (cleaning liquid) is present in the flow-through region 122, the resulting electrical resistance between the first electrode 128 and the second electrode 130 is relatively low. When no liquid is present in the flow-through region 122, an air bridge is formed between the first electrode 128 and the second electrode 130 in the flow-through region 122.

Preferably, the wall 132 is made of a plastics material having electrical insulating properties. Therefore, with no liquid present in the flow-through region 122 and, hence, no liquid present between the first electrode 128 and the second electrode 130, the resulting resistance is high. It is thus possible to determine, from a resistance determination, whether or not liquid is present in the flow-through region 122. If it is detected that no liquid is present in the flow-through region 122, then this means that the tank device 34 for cleaning liquid is emptied or is empty.

Here, it is in particular provided that in the surface cleaning machine 10, under the normally intended conditions of use, when it is supported on the surface 16 to be cleaned via the cleaning roller unit 18, the flow-through region 122 is, relative to the direction of gravity g, located below the tank device 34 for cleaning liquid and here below the outlet 118 thereof.

When the valve device 38 is located downstream of the flow-through region 122, then this means that, under the normally intended conditions of use, the flow-through region 122 is filled with liquid when the tank device 34 is inserted in place and holds sufficient liquid. By way of example, this enables a check to be made as to whether there is sufficient cleaning liquid for cleaning action even before the rotary drive is turned on (via the drive motor 28).

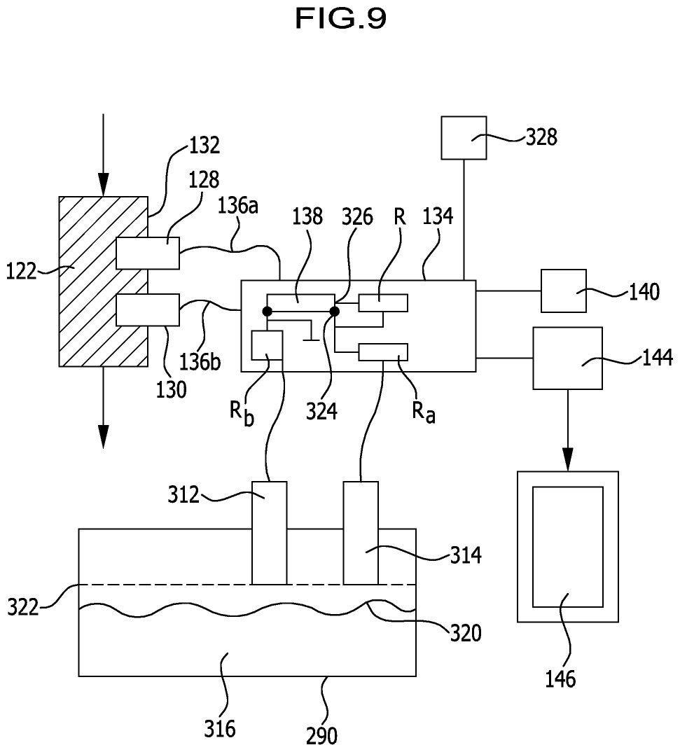

The evaluation device 134 also serves to control the sensor device 126 having the electrodes 128, 130. To this end, the evaluation device 134 comprises an ASIC 138 for example (FIG. 9).

To perform a measurement using the sensor device 126, for example, a direct voltage (which can also be pulsed) is applied between the first electrode 128 and the second electrode 130. A falling voltage is measured as a reaction signal.

With liquid present in the flow-through region 122, a resistance due to the medium occurs between the first electrode 128 and the second electrode 130. When no liquid is present between the first electrode 128 and the second electrode 130, then the resistance can be taken as an idealized, infinitely large resistance.

When liquid is present between the electrodes 128, 130, a current can flow. The resistance is thereby made finite. By simply performing a threshold check in terms of the resistance, the presence of liquid in the flow-through region 122 can then be determined via the evaluation device 134.

The sensor device 126 is operatively connected to the evaluation device 134 for signal communication therewith. The evaluation device 134 is operatively connected to an indication device 140 for signal communication therewith. The indication device 140 comprises a visual and/or audible indication. In an embodiment, the indication device 140 comprises a visual indicator 142 which is arranged at the grip 26.

The visual indicator 142 indicates, for example by flashing or the like, that the tank device 34 for cleaning liquid is empty.

Alternatively or additionally, the evaluation device 134 is operatively connected to a transmitter 144 for signal communication therewith. Corresponding signals, and in particular warning signals or indicator signals, can be sent via the transmitter 144 to a remote control 146 or a mobile device, such as a smartphone. This can then provide a corresponding warning indication or it can provide a readout as to whether or not the degree of fill of the tank device 34 for cleaning liquid is sufficient.

The sensor device 126 provides a simple way of recognizing an empty status of the tank device 34 for cleaning liquid, and the corresponding status can be easily notified to a user via the indication device 140. Here, said determination is substantially position-independent as a result of the arrangement of the flow-through region 122 below the port 120.

The flow-through region 122 is arranged at the transverse region 114 of the holder 32 and is in particular fixedly connected thereto. The system having the sensor device 126 can thereby be configured with simple structure. No part of the sensor device 126 has to have a movable configuration, i.e., no consideration need be given to a removal of the tank device 34 when constructing the sensor device 126. A sloshing motion of liquid in the tank device 34 for cleaning liquid and a position-dependent liquid level in the tank device 34 for cleaning liquid will have no effect on the sensor device 126.

Here the sensor device 126 is external to the tank device 34 for cleaning liquid. A current between the first electrode 128 and the second electrode 130 collapses when the tank device 34 for cleaning liquid is empty, whereby liquid is no longer present in the flow-through region 122.

Here, the following capabilities are provided via the evaluation device 134:

If, prior to starting operation of the rotary drive, the tank device 34 for cleaning liquid is recognized to be empty, rotational drive to the cleaning roller unit 18 can be prevented via the evaluation device 134.

If, during operation of the surface cleaning machine 10 (while the cleaning roller unit 18 is being rotated), the tank device 34 for cleaning liquid is recognized to have emptied, the evaluation device 134 can initiate a corresponding indicator signal, and in particular a warning signal, via the indication device 140 or via the transmitter 144.

If emptying of the tank device 34 for cleaning liquid is recognized while the surface cleaning machine 10 is running, then the evaluation device 134 can provide for the rotary action of the cleaning roller unit 18 to be turned off by corresponding control of the drive motor 28. For example, damage to a surface 16 to be cleaned is thereby prevented.

The surface cleaning machine 10 works as follows:

When in a cleaning mode of operation, the dirty fluid tank device 66 is fixed in place to the cleaning head 14 in the holding position.

For cleaning action, the surface cleaning machine 10 is supported on the surface 16 to be cleaned entirely by the cleaning roller unit 18. The drive motor 28 imparts drive to the cleaning roller unit 18 for rotary movement about the (single) axis of rotation 58 in the direction of rotation 158.

The cleaning roller unit 18 is supplied with cleaning liquid from the tank device 34.

Dirt on the surface 16 to be cleaned, when acted upon by the wetted cleaning substrate 42 of the cleaning roller unit 18, is wetted to facilitate loosening of the dirt.

The rotation of the cleaning roller unit 18 causes a mechanical action on dirt present on the surface 16 to be cleaned in order to enhance the dislodgeability of the dirt from the surface 16 being cleaned.

Coarse debris, when present, can be fed to the cleaning roller unit 18 by way of a sweeping element.

Dirty fluid (dirt particles, cleaning liquid with loosened dirt) is picked up by the cleaning roller unit 18 and, at the scraper/guide device 110, the dirty fluid is loosened from the cleaning roller unit 18 and is directed (inter alia by centrifugal action) into the inlet mouth 112, thence entering the tank device 66 for dirty fluid. The scraper/guide device 110 provides for loosening of dirty fluid from the cleaning substrate 42 of the cleaning roller unit 18 by way of a scraping action.

In particular, the incoupling of dirty fluid into the tank device 66 for dirty fluid is realized without suction fan assistance.

In an alternative embodiment, provision is made for dirty fluid to be suctioned from the cleaning roller unit 18 via a corresponding suction device.

Via the evaluation device 134 having the sensor device 126, it is possible to recognize whether the tank device 34 for cleaning liquid is empty. Corresponding measures can then be initiated via the evaluation device 134.

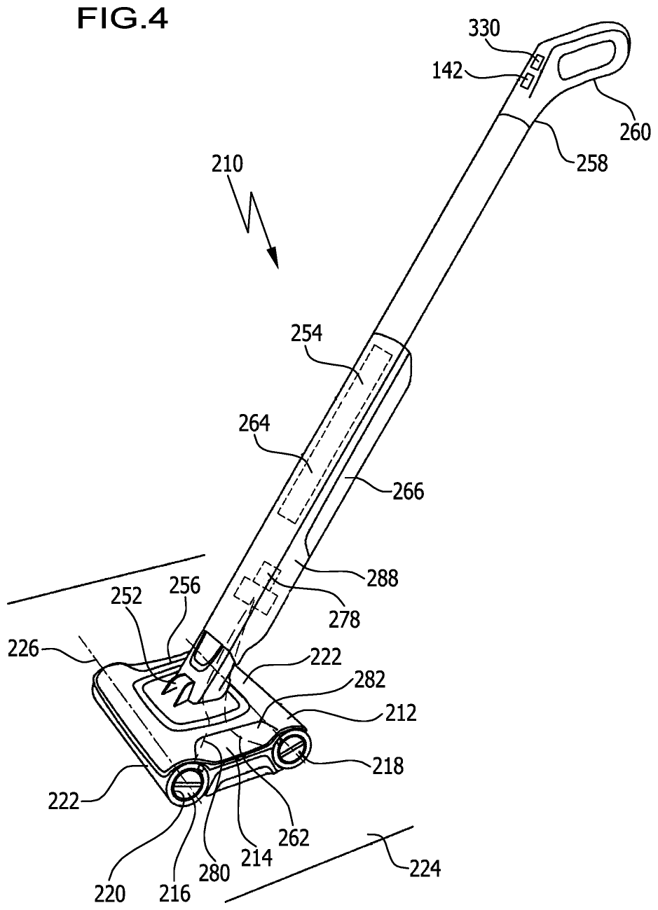

A second exemplary embodiment of a surface cleaning machine 210 (FIGS. 4 to 7) comprises a cleaning head 212. The cleaning head 212 has a head body 214. Arranged at the head body 214 are a first cleaning roller unit 216 and a second roller unit in the form of a second cleaning roller unit 218, which cleaning roller units are spaced apart from one another.

In an embodiment, the first cleaning roller unit 216 and the second cleaning roller unit 218 are of one-part construction, i.e., the respective cleaning roller unit is formed by a one-part cleaning roller.

In principle, it is also possible for the first cleaning roller unit 216 and/or the second cleaning roller unit 218 to be of multi-part construction and, in particular, to be in each case of two-part construction.

The first cleaning roller unit 216 and the second cleaning roller unit 218 each comprise a (cylindrical) support 220, on which is arranged a cleaning substrate 222 made of a textile material. Via the cleaning substrate 222, the surface cleaning machine, with its cleaning head 212, acts on a surface 224 that is to be cleaned.

The first cleaning roller unit 216 is driven for rotary movement about a first axis of rotation 226 (when the surface cleaning machine 210 is in use).

The second cleaning roller unit 218, when in operation, is driven for rotary movement about a second axis of rotation 228. The first axis of rotation 226 and the second axis of rotation 228 extend in spaced, parallel relation to each other.

When the cleaning head 212 having the first cleaning roller unit 216 and the second cleaning roller unit 218 is placed on a flat surface 224 that is to be cleaned, wherein it is supported on the surface 224 to be cleaned via the first cleaning roller unit 216 and the second cleaning roller unit 218, then the first axis of rotation 226 and the second axis of rotation 228 are each oriented parallel to the surface 224 that is to be cleaned.

The surface cleaning machine 210 comprises a drive device 230 for rotatingly driving the first cleaning roller unit 216 and the second cleaning roller unit 218.

In an exemplary embodiment, the drive device 230 comprises a first drive 232 which drives the rotational movement of the first cleaning roller unit 216, and a second drive 234 which drives the rotational movement of the second cleaning roller unit 218.

The first drive 232 and the second drive 234 are formed by electric motors in particular.

In particular, the first drive 232 and the second drive 234 are positioned within the support 220 of the first cleaning roller unit 216 and the support 220 of the second cleaning roller unit 218 respectively.

It is then provided in particular for the first cleaning roller unit 216 and the second cleaning roller unit 218 each to be of one-part configuration.

Provision is made for the first cleaning roller unit 216 to be driven for rotary movement in a first direction of rotation 236, and for the second cleaning roller unit 218 to be driven for rotary movement in a second direction of rotation 238. Here the first direction of rotation 236 and the second direction of rotation 238 oppose each other, i.e., the first cleaning roller unit 216 and the second cleaning roller unit 218 are driven in counterrotation.

Here the first direction of rotation 236 is such that a first area 240 with which the first cleaning roller unit 216 has acted on the surface 224 to be cleaned is first moved towards an area 242 which is located between the first cleaning roller unit 216 and the second cleaning roller unit 218 at the head body 214.

Correspondingly, the second direction of rotation 238 is such that a second area 244 with which the second cleaning roller unit 218 has acted on the surface 224 to be cleaned is moved towards the area 242 at the head body 214.

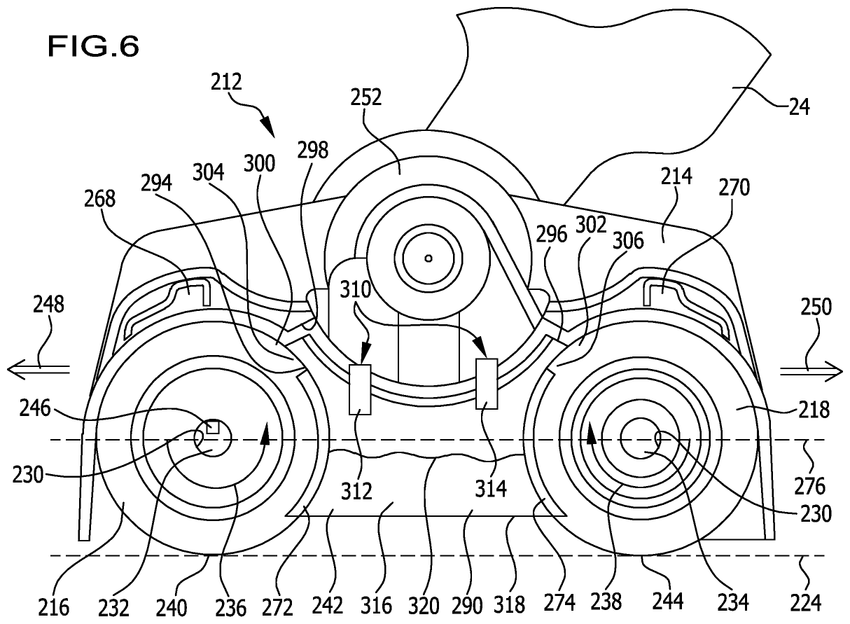

In an embodiment, the surface cleaning machine 210 comprises an adjustment device (indicated by reference numeral 246 in FIG. 6) by way of which a user can adjust a rotational speed of the first cleaning roller unit 216 in the first direction of rotation 236 and/or a rotational speed of the second cleaning roller unit 218 in the second rotational direction 238.

When the first cleaning roller unit 216 and the second cleaning roller unit 218 rotate at the same rotational speed, the cleaning head 212 experiences no advance movement due to rotation of the cleaning roller units 216 and 218.

When the first cleaning roller unit 216 rotates at a rotational speed greater than the rotational speed of the second cleaning roller unit 218, the cleaning head 212 experiences an advance movement in a first advance direction 248. When the second cleaning roller unit 218 rotates at a rotational speed greater than the rotational speed of the first cleaning roller unit 216, the cleaning head 212 experiences an advance movement in a second advance direction 250.

The first advance direction 248 and the second advance direction 250 are opposite to each other.

The first advance direction 248 and the second advance direction 250 are transverse and in particular at right angles to the axes of rotation 226 and 228.

Via corresponding adjustment on the adjustment device 246, control can be had over whether no advance movement will occur or whether an advance movement takes place in the first advance direction 248 or in the second advance direction 250.

A holding rod device 254 is held to the cleaning head 212 via a joint 252. Via the joint 252, the holding rod device 254 can be pivoted about a pivot axis 256 relative to the cleaning head 212 when the cleaning head 212 stands with its first cleaning roller unit 216 and the second cleaning roller unit 218 on the surface 224 to be cleaned.

Here the pivot axis 256 is parallel to the first axis of rotation 226 and the second rotation axis 228.

Provided on the holding rod device 254, at a proximal end 258 thereof, is a (hand) grip, and a loop-type grip 260 in particular. The holding rod device is articulated to the cleaning head 212 via the joint 252 in the area of a distal end 262 thereof.

A user standing on the surface 224 to be cleaned, behind the cleaning head 212, can grasp the loop grip 260 with one hand. The pivoting capability of the holding rod device 254 at the joint 252 allows a pivot angle of the holding rod device 254 relative to the surface 224 to be cleaned to be adjustable; in particular, a user can adjust the pivot angle to suit his or her physical size.

The surface cleaning machine 210 is hand-held and, thereby, hand-guided by way of the loop grip 260.

Arranged at the holding rod device 254 is a battery device 264 which is in particular rechargeable. The drive device 230 has its electrical energy supplied from the battery device 264.

In principle, it is also possible for the holding rod device to have arranged thereon a terminal for connection to the electrical power grid, in which case the drive device 230 can have its electrical energy supplied from the power grid.

Furthermore, a tank device 266 for cleaning liquid is arranged at the holding rod device 254.

At least one duct is routed from the tank device 266 through the holding rod device 254 to the cleaning head 212 and through the cleaning head 212 to a first outlet mouth device 268 which is associated with the first cleaning roller unit 216, and to a second outlet mouth device 270 which is associated with the second cleaning roller unit 218.

In an embodiment, the tank device 266 is associated with a sensor device corresponding to the sensor device 126 as described above.

Here the first outlet mouth device 268 is arranged above the first cleaning roller unit 216, relative to a height direction pointing away from the surface 224 to be cleaned when the cleaning head 212 stands thereon as normally intended, and the second outlet mouth device 270 is arranged above the second cleaning roller unit 218.

In an exemplary embodiment, the tank device 266 for cleaning liquid is associated with a valve device which is configured to automatically open when the drive device 230 is operated, thereby allowing passage of cleaning liquid from the tank device 266 via the first outlet mouth device 268 and onto the first cleaning roller unit 216 and via the second outlet mouth device 270 onto the second cleaning roller unit 218.

In particular, the first outlet mouth device 268 and the second outlet mouth device 270 are configured such that the first cleaning roller unit 216 and the second cleaning roller unit 218 have cleaning liquid applied thereto over a large part of their lengths, parallel to the axes of rotation 226, 228 respectively.

An area of the first cleaning roller unit 216 which has previously received cleaning liquid via the first outlet mouth device 268 rotates in the first direction of rotation 236 towards the surface 224 to be cleaned and then, upon acting on this surface 224 to be cleaned, forms the first region 240. The first cleaning roller unit 216 acts mechanically on the surface 224 to be cleaned. Its “liquid content” acts to break up and loosen the dirt, thereby enhancing the cleaning effect.

Correspondingly, a wetted region of the second cleaning roller unit 218 rotates in the second direction of rotation 238 towards the surface 224 to be cleaned and forms the second area 244 in the same way as has been described for the first cleaning roller unit 216.

The first cleaning roller unit 216, after it has acted on the surface 224 to be cleaned, picks up dirt in the first direction of rotation 236. The second cleaning roller unit 218 picks up dirt in the second direction of rotation 238.

In principle, it is also possible for the tank device 266 to be arranged at the cleaning head 212.

A first sweeping element 272 is located at the cleaning head 212 and is associated with the first cleaning roller unit 216. Furthermore, a second sweeping element 274 is located at the cleaning head 212 and is associated with the second cleaning roller unit 218.

The first sweeping element 272 and the second sweeping element 274 project beyond the head body 214 in a downward direction, towards the surface 224 that is to be cleaned.

The first sweeping element 272 has the function of holding coarse debris in place, i.e., of preventing coarse debris from an area in the vicinity of the first cleaning roller unit 216 from reaching the second cleaning roller unit 218. Coarse debris, in a sense, can then be gathered at the first sweeping element 272 and can then be picked up by the rotary motion of the first cleaning roller unit 216 in the first direction of rotation 236.

The second sweeping element 274 has the same function relative to the second cleaning roller unit 218.

In principle, it is also possible for only the first sweeping element 272 or only the second sweeping element 274 to be present.

In an embodiment, the surface cleaning machine 210 comprises a fan device 278. The fan device comprises a fan and a drive motor, and an electric motor in particular. The electric motor is electrically powered from the battery device 264 or alternatively from the mains grid. The fan device 278 generates a negative pressure to develop a suction flow.

Ducts 280, 282 are routed from the fan device 278 to a first inlet mouth device 284 (FIG. 5) which is associated with the first cleaning roller unit 216 and to a second inlet mouth device 286 which is associated with the second cleaning roller unit 218.

The corresponding suction flow allows dirty fluid to be suctioned from the first cleaning roller unit 216 and to be outcoupled via the first inlet mouth device 284. Furthermore, dirty fluid can be suctioned from the second cleaning roller unit 218 and outcoupled via the second inlet mouth device 286.

Associated with the fan device 278 is a tank device 288 for dirty fluid which serves for incoupling dirty fluid into same.

The tank device 288 can be arranged, and can in particular be releasably arranged, at the holding rod device 254.

In an embodiment, the tank device 288 is arranged at the cleaning head 212, in particular between the first cleaning roller unit 216 and the second cleaning roller unit 218. Such a tank device is indicated in FIG. 6 by the reference numeral 290.

The dirty fluid tank devices 288 and 290 are operatively connected to the fan device 278 for fluid communication therewith so that dirty fluid can be incoupled thereinto.

In an exemplary embodiment, the first inlet mouth device 284 is located upstream of the first outlet mouth device 268, relative to the first direction of rotation 236, i.e., the first region 240 that has acted upon the surface 224 to be cleaned is first moved past the first inlet mouth device 284 before it is moved past the first outlet mouth device 268. This analogously applies to the second cleaning roller unit 218 and the second area 244 thereof in connection with the second inlet mouth device 286.

The first inlet mouth device 284 is arranged between the first sweeping element 272 and the first outlet mouth device 268, relative to the first direction of rotation 236.

The second inlet mouth device 286 is arranged between the second sweeping element 274 and the second outlet mouth device 270, relative to the direction of rotation 238.

The positions of the first inlet mouth device 284 and the second inlet mouth device 286 are indicated in FIG. 5. The first inlet mouth device 284 points into a first receptacle 292 of the cleaning head 212 in which the first cleaning roller unit 216 is arranged. Here the first inlet mouth device 284 is arranged above the first cleaning roller unit 216, relative to a height direction pointing away from the surface 224 to be cleaned when the cleaning head 212 is placed as normally intended with the first cleaning roller unit 216 and the second cleaning roller unit 218 supported on the surface being cleaned.

The second inlet mouth device 286 is correspondingly arranged in relation to the second cleaning roller unit 218. The second cleaning roller unit 218 is located in a second receptacle 294 of the cleaning head 212, and the second inlet mouth device 286 points into the second receptacle 294.

Dirty fluid can thereby be sucked off directly from the first cleaning roller unit 216 and the second cleaning roller unit 218.

Here the first inlet mouth device 284 and the second inlet mouth device 286 have a mouth length parallel to the first axis of rotation 226 and the second axis of rotation 228 respectively, such that a correspondingly large part of the lengths of the first cleaning roller unit 216 and the second cleaning roller unit 218 respectively, can have suction applied thereto.

For example, it is also possible for only inlet mouth devices corresponding to the inlet mouth devices 296 and 298 which are arranged next to the respective first cleaning roller unit 216 and 218 to be operatively connected to the fan device 278 for fluid communication therewith. For example, it is possible for the first cleaning roller unit to have associated therewith a first inlet mouth device 300 and for the second cleaning roller unit 218 to have associated therewith a second inlet mouth device 302, which inlet mouth devices open directly into the tank device 290 (FIG. 6). In particular, the first inlet mouth device 300 and the second inlet mouth device 302 then have a respective scraper 304 and 306 associated therewith which scrapes dirty fluid from the first cleaning roller unit 216 and second cleaning roller unit 218, respectively, wherein dirty fluid can then be incoupled directly into the tank device 290 via the first inlet mouth device 296 and the second inlet mouth device 298, in particular wherein the first inlet mouth device 300 and the second inlet mouth device 302 are then not coupled to the fan device 278. By way of example, it is then provided for having a suction action at the inlet mouth devices 296, 298 and a direct scraping/incoupling action at the inlet mouth devices 300 and 302.

In order to operate the surface cleaning machine 210, the cleaning head 212 is placed on the surface to be cleaned via the first cleaning roller unit 216 and the second cleaning roller unit 218. These are rotatably driven in the first direction of rotation 236 and the second direction of rotation 238 respectively. By varying the rotational speed, an advance movement in the directions 248 and 250 respectively can be adjusted.

Application of cleaning liquid to the respective cleaning roller unit 216 and 218 is accomplished via cleaning liquid from the tank device at the first outlet mouth device 268 and the second outlet mouth device 270 respectively. Via the first area 240 of the first cleaning roller unit 216 and the second area 244 of the second cleaning roller unit 218, the respective rotating cleaning roller unit 216, 218 exerts a mechanical action on the surface to be cleaned, thereby loosening dirt therefrom. Wetting via cleaning liquid at the tank device aids in loosening dirt.

Dirt is picked up by the cleaning substrate 222 of the first and the second cleaning roller unit 216, 218 and is transferred in the first direction of rotation 236 or second direction of rotation 238 respectively.

Coarse dirt that may gather at the first sweeping element 272 and the second sweeping element 274 is picked up in the first direction of rotation 236 and second direction of rotation 238 respectively.

Depending on the particular configuration of the cleaning head 212, dirty fluid is, for example, sucked off at the first inlet mouth device 284 and the second inlet mouth device 286 via the fan device 278.

It is also possible for dirty fluid to be incoupled into the tank device 290 for dirty fluid by way of a scraping action, without fan assistance, at a corresponding first inlet mouth device 300 and a second inlet mouth device 302 (cf. FIG. 6).

The surface cleaning machine 210 comprises two counter-rotating cleaning roller units 216, 218. Full contact pressure with the surface 224 to be cleaned can thereby be achieved independently of the pivot position of the holding rod device 254 with respect to the surface 224 being cleaned.

Furthermore, a constant distance of the sweeping elements 272, 274 with respect to the surface 224 being cleaned can be maintained.

Furthermore, dirt that gets thrown past one cleaning roller unit 216 or 218 can be captured by the other cleaning roller unit 218 or 216.

The tank device 290 for dirty fluid is positioned between the first cleaning roller unit 216 and the second cleaning roller unit 218. A short transfer path for dirty fluid is thereby obtained, at least for the case of the direct incoupling thereof. Furthermore, a low center of gravity can be maintained and the tank device can be cleaned with little effort.

The tank device 290 for dirty fluid has associated therewith a probe device 310 (FIGS. 4 to 7, FIG. 9) by which a degree of fill of the tank device 290 with dirty fluid can be determined.

In particular, the probe device 310 is configured as an electrode device, or resistance measuring device. To this end, the probe device 310 comprises a first electrode 312 and a second electrode 314 arranged in spaced relation to the first electrode 312.

The first electrode 312 and the second electrode 314 are arranged and configured such that they project into a receiving space 316 of the tank device 290 for dirty fluid.

Here the electrodes are positioned at a distance to a tank bottom 318 of the tank device 290 for dirty fluid. They are arranged such that when the liquid level 320 (cf. FIG. 6) within the receiving space 316 rises, said liquid level 320 will rise in the direction of the electrodes 312, 314.

A direct voltage is applied between the first electrode 312 and the second electrode 314. The direct voltage can be a pulsed voltage.

When the liquid level 320 is below the electrodes 312, 314 (cf. FIG. 9), an air bridge exists between the electrodes 312, 314 and no current can flow therebetween. The electrical resistance between the first electrode 312 and the second electrode 314 can be taken as an idealized, infinitely large resistance.

When the liquid level 320 reaches the electrodes 312, 314, then a current can flow via the liquid between the first electrode 312 and the second electrode 314. The resistance thereby becomes finite. The transition from the idealized, infinite resistance to the finite resistance can be measured. A determination can thereby be made as to whether the liquid level 320 reaches a particular degree of fill 322. The particular degree of fill 322 is predetermined by the arrangement of the first electrode 312 and the second electrode 314.

In particular, the probe device 310 is connected to an evaluation device. In an embodiment, said evaluation device corresponds to the evaluation device 134 for the sensor device 126. Provision may be made for a separate evaluation device to be provided for the probe device 310.

For example, a voltage is applied between the first electrode 312 and the second electrode 314 via a terminal 324 of an ASIC, particularly the ASIC 138. The corresponding voltage forms an application signal. The corresponding reaction signal is a falling voltage which is present at a terminal 326 in particular.

A resistance is present between the first electrode 312 and the second electrode 314. With no liquid present between the electrodes, this resistance can be taken as an idealized, infinitely large resistance. When the liquid level 320 reaches the electrodes 312, 314, then a current can flow. The resistance thereby becomes finite and the voltage at the terminal 326 changes. This change is caused by the liquid level 320 reaching a particular degree of fill 322. This threshold value 322 can thereby be detected and the liquid level 320 can be determined at least “digitally”.

Provision is made for an indication device 328 to be provided which indicates to a user visually and/or audibly when the particular degree of fill 322 of the tank device 290 for dirty fluid is reached. The indication device 328 comprises an optical and/or acoustic element 330 which is in particular arranged at the grip 60. For example, the optical element 330 flashes when the particular degree of fill 322 is reached.

Alternatively or additionally, the evaluation device 134 is operatively connected to a transmitter, corresponding to the transmitter 144, for signal communication therewith in order to be able to provide corresponding warning signals or indicator signals to a remote control or a mobile device 146.

In particular, the evaluation device 134 provides the following:

The evaluation device 134 supplies a direct voltage to the probe device 310, which direct voltage can also be a pulsed direct voltage. The resulting reaction signal which is in particular present at the terminal 326 is a voltage. A resistance measurement can be performed at least indirectly. A check can thereby be made as to whether the particular degree of fill 322 is reached.

In principle, in operation of the surface cleaning machine 210, sloshing motions of liquid can occur within the receiving space 316 of the tank device 290. Provision is made for the evaluation device 134 to comprise a filter device that can detect short duration changes in resistance. With respect to the determination of the degree of fill 322, only conditions of longer duration are utilized. Thus, a reliable determination can be made as to whether the particular degree of fill 322 is reached; sloshing events, which are of a short duration, can thereby in a sense be filtered out.

When it is recognized that the particular degree of fill 322 is reached (and sustained), then the evaluation device 134 provides for a corresponding signal to be applied to the indication device 328 or the transmitter 144. In particular, corresponding warning signals are initiated or emitted.

It may also be provided that, when it is recognized that the particular degree of fill 322 is reached, a rotary drive of the cleaning roller units 16, 18 is turned off and/or operation of a fan device is turned off in order to prevent continued incoupling of dirty fluid into the tank device 290.

It may also be provided that, for example, when it is recognized prior to, for example, starting operation of the surface cleaning machine 210 that the particular degree of fill 322 is reached, a rotary drive of the cleaning roller units 216, 218 is inhibited or operation of a fan device is inhibited.

In principle, it is possible for the probe device 310 to be also used, for example, in the surface cleaning machine 10 in which the corresponding tank device 34 for cleaning liquid has associated therewith the sensor device 126.

It is further possible for a probe device corresponding to the probe device 310 to be used for the tank device 66 for dirty fluid of the surface cleaning machine 10.

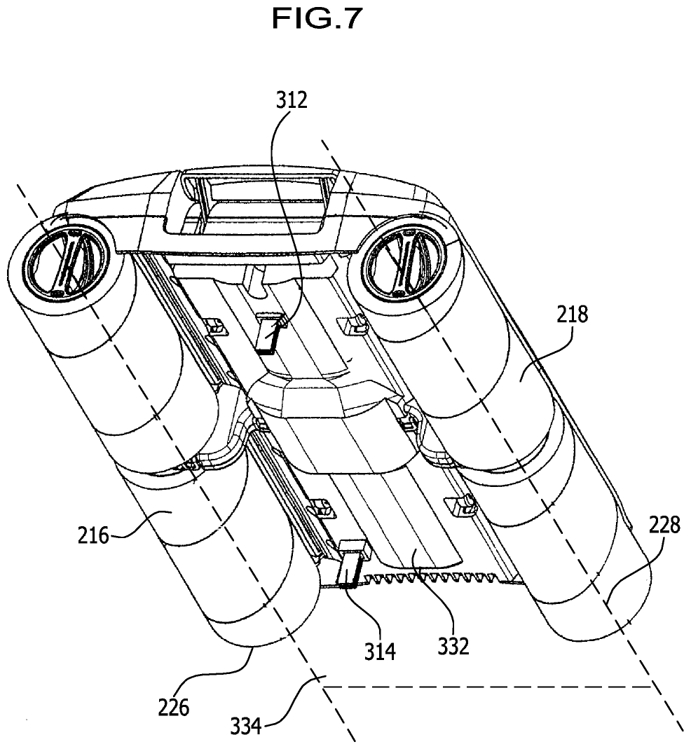

In the surface cleaning machine 210, the tank device 290 for dirty fluid is positioned between the first cleaning roller unit 216 and the second cleaning roller unit 218. A cover wall 332 is provided (cf. FIG. 7) which covers the tank device 290 towards the top thereof (the tank device 290 is removed in FIG. 7).

The first electrode 312 and the second electrode 314 are located at the cover wall 332. They are oriented transversely to a plane 334 (FIG. 7), wherein the plane 334 contains the first axis of rotation 226 and the second axis of rotation 228.

In an embodiment, the cover wall 332 forms a lid for the tank device 290 for dirty fluid.

In an embodiment in which the surface cleaning machine, for cleaning action, is supported via the first cleaning roller unit 216 and the second cleaning roller unit 218 on the surface 224 to be cleaned, with the tank device 290 being removably positioned at the cleaning head 212, between the cleaning roller units 216, 218, the position of the tank device 290 during cleaning action is held in a very stable position relative to the surface 224 to be cleaned; it is only when unevenness in the surface 224 to be cleaned is encountered that vibrations can be developed. The particular degree of fill 322 can thereby be reliably measured.

Fill level recognition is achieved simply by making a resistance measurement. There is no need for specialized, expensive and vulnerable sensors. Vulnerability to contact with dirt in the dirty fluid can also be kept low.

The first electrode 312 and the second electrode 314 are in particular configured in the form of metal pins which project into the receiving space 316. When the particular degree of fill 322 is reached, then the electrodes 312, 314 are in current-conducting communication with one another. Sloshing liquid can be recognized and “sorted out” via the evaluation device 134 and its filter device. This provides a way of ensuring that, when a current flows due to the sloshing motion of liquid, this is not misinterpreted as the particular degree of fill 322 being reached.

In principle, it is possible for the probe device 310 to comprise a plurality of electrode pairs. This provides a way of detecting levels at different intermediate stages before the particular degree of fill 322 is reached.

As mentioned above, the probe device 310 can also be used, for example, in the tank device 66 of the surface cleaning machine 10.

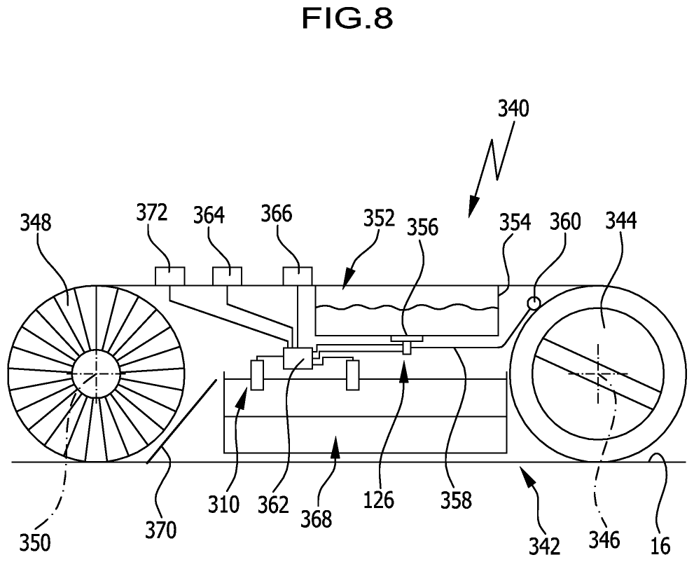

A third exemplary embodiment of a surface cleaning machine in accordance with the invention, shown schematically in FIG. 8 and designated therein by 340, is a self-propelled and self-steering apparatus (“cleaning robot”).

The surface cleaning machine 340 comprises a cleaning head 342. Arranged at the cleaning head 342 is a first cleaning roller unit 344. The first cleaning roller unit 344 can be rotated about a first axis of rotation 346. To this end, a corresponding rotary drive (not shown in FIG. 8) is arranged at the cleaning head 342.

A second roller unit 348 is arranged at the cleaning head 342, in spaced relation to the first cleaning roller unit 344. The second roller unit is rotatable about a second axis of rotation 350. In particular, it is driven for rotary movement via a corresponding rotary drive.

The cleaning head 342, and hence the surface cleaning machine 340, is supported on the surface 16 to be cleaned via the first cleaning roller unit 344 and the second cleaning roller unit 348.

The second roller unit 348 is configured as a sweeping roller unit, for example.

A wetting device 352 is provided via which (at least) the first cleaning roller unit 344 can be supplied with cleaning liquid (fresh water with or without added cleaning agent). The wetting device 352 comprises a tank device 354 for cleaning liquid. The tank device 354 is arranged at the cleaning head 342.

Associated with the tank device 354 is a flow-through region 356. Located at the flow-through region 356 is a sensor device corresponding to the sensor device 126. Like elements are identified with the same reference numerals.

One or more conduits 358 are routed from the flow-through region 356 to a nozzle device 360 by way of which the first cleaning roller unit 344 can have cleaning liquid applied thereto.

The sensor device 126 is operatively connected to an evaluation device 362 for signal communication therewith, said evaluation device 362 corresponding to the evaluation device 134.

Via the sensor device 126, a determination can be made as to whether the tank device 354 is empty. This is indicated on an indication device 364 which is located at the cleaning head 342.

It is also possible for a transmitter 366 to be controlled via the evaluation device 362 in order, for example, to provide to a mobile device, such as a smartphone, an indication of the degree of fill of the tank device 354 for cleaning liquid, or to give a warning indication.

Further, a tank device 368 for dirty fluid is removably arranged at the cleaning head 342. Dirty fluid which is loosened or suctioned from the first cleaning roller unit 344 is incoupled into the tank device 368.

In principle, it is also possible, for example, for sweepings to be fed to the tank device 368 via a ramp 370.

Associated with the tank device 368 is a probe device corresponding to the probe device 310. Here, at least two electrodes project into a receiving space of the tank device 368. The corresponding probe device 310 is operatively connected to the evaluation device 362 for fluid communication therewith.

The degree of fill of the tank device 368 can thereby be determined, in particular wherein a determination can be made as to whether a particular degree of fill is reached.

The evaluation device 362 is operatively connected to an indication device 372 for signal communication therewith, wherein the indication device 372 is associated with the probe device 310. The indication device 372 is arranged at the cleaning head 342. It provides (visual and/or audible) indication as to whether the particular degree of fill of the tank device 368 is reached.

Likewise, the transmitter 366 can be used to initiate a corresponding status signal or warning signal for a smartphone or the like.

By way of example, the surface cleaning machine 340 is parked or travels to a station (particularly a charging station) when it is detected that the tank device 354 is emptied and/or that the tank device 368 has reached its particular degree of fill.

Otherwise, the probe device 310 or the sensor device 126 cooperate with the evaluation device 362 in the same manner as has been described in the context of the evaluation device 134.

### LIST OF REFERENCE CHARACTERS

10 surface cleaning machine (first exemplary embodiment)
12 apparatus body
14 cleaning head
16 surface to be cleaned
18 cleaning roller unit
20 longitudinal axis
22 holding rod device
24 holding rod
26 (hand) grip
28 drive motor
30 housing
32 holder
34 tank device for cleaning liquid
38 valve device
39 filter device
40 fluid conduit
42 cleaning substrate
44 battery device
46 motor axis
48 pivot axis
52 inner sleeve
54 outer sleeve
56 pivot bearing
58 axis of rotation
60 cleaning roller holder
62 holding region
64 receiving chamber
66 tank device for dirty fluid
70 shaft
72 first part
74 second part
76 intermediate region
78 sleeve
80 first end face
82 second end face
88 receiving space
100 holding position
102 flap
106 pivot bearing
108 direction
110 scraper/guide device
112 inlet mouth
114 transverse region
116 retaining bar
118 outlet
120 port
122 flow-through region
124 flow direction
126 sensor device
128 first electrode
130 second electrode
132 wall
134 evaluation device
136a line
136b line
138 ASIC
140 indication device
142 visual indicator
144 transmitter
146 remote control, mobile device
210 surface cleaning machine (second exemplary embodiment)
212 cleaning head
214 head body
216 first cleaning roller unit
218 second cleaning roller unit
220 support
222 cleaning substrate
224 surface to be cleaned
226 first axis of rotation
228 second axis of rotation
230 drive device
232 first drive
234 second drive
236 first direction of rotation
238 second direction of rotation
240 first area
242 area
244 second area
246 adjustment device
248 first advance direction
250 second advance direction
252 joint
254 holding rod device
256 pivot axis
258 proximal end
260 loop grip
262 distal end
264 battery device
266 tank device for cleaning liquid
268 first outlet mouth device
270 second outlet mouth device
272 first sweeping element
274 second sweeping element
278 fan device
280 duct
282 duct
284 first inlet mouth device
286 second inlet mouth device
288 tank device for dirty fluid
290 tank device for dirty fluid
296 first inlet mouth device
298 second inlet mouth device
300 first inlet mouth device
302 second inlet mouth device
304 scraper
306 scraper
310 probe device
312 first electrode
314 second electrode
316 receiving space
318 tank bottom
320 liquid level
322 particular degree of fill
324 terminal
326 terminal
328 indication device
330 optical and/or acoustic element
332 cover wall
334 plane
340 surface cleaning machine (third exemplary embodiment)
342 cleaning head
344 first cleaning roller unit
346 first axis of rotation
348 second roller unit
350 second axis of rotation
352 wetting device
354 tank device for cleaning liquid
356 flow-through region
358 conduit
360 nozzle device
362 evaluation device
364 indication device
366 transmitter
368 tank device for dirty fluid
370 ramp
372 indication device

1. A surface cleaning machine, comprising:
a cleaning head having at least one cleaning roller unit which is driven for rotary movement; and
a tank device for dirty fluid;
wherein a probe device is provided for determining a degree of fill of the tank device for dirty fluid.

2. The surface cleaning machine in accordance with claim 1, wherein the probe device is configured as a resistance measuring device.

3. The surface cleaning machine in accordance with claim 1, wherein the probe device is configured as an electrode device.

4. The surface cleaning machine in accordance with claim 3, wherein the electrode device comprises a first electrode and a second electrode in spaced relation to the first electrode, which electrodes project into a receiving space of the tank device for dirty fluid.

5. The surface cleaning machine in accordance with claim 4, wherein the first electrode and the second electrode are fixedly connected to a holder for the tank device for dirty fluid, wherein the tank device for dirty fluid is releasable from the holder.

6. The surface cleaning machine in accordance with claim 3, wherein the electrode device is arranged and configured such that a particular degree of fill of the tank device for dirty fluid is detectable.

7. The surface cleaning machine in accordance with claim 3, wherein provision is made for applying a direct current or a direct voltage to the electrode device.

8. The surface cleaning machine in accordance with claim 1, wherein the probe device is operatively connected to an evaluation device for signal communication therewith, wherein at least one of the following conditions is satisfied:
the evaluation device controls at least one of an indication device and a transmitter;
the evaluation device initiates a warning signal for at least one of the indication device and the transmitter when the reaching of a particular degree of fill is detected;
the evaluation device checks a degree of fill of the tank device for dirty fluid via a resistance determination;
the evaluation device controls the probe device;
the evaluation device comprises a filter device which checks for variations with time in the signals of the probe device;
the evaluation device turns off at least one of (i) drive to the at least one cleaning roller unit and (ii) transfer or transferability of cleaning liquid when a particular degree of fill is detected at the tank device for dirty fluid;
the evaluation device prevents at least one of rotary drive to the at least one cleaning roller and suction operation if, when starting operation of the surface cleaning machine, the particular degree of fill is detected.

9. The surface cleaning machine in accordance with claim 8, wherein the indication device is at least one of (i) arranged at a hand grip via which the cleaning head is guidable by a user and (ii) arranged at the cleaning head.

10. The surface cleaning machine in accordance with claim 1, wherein a first cleaning roller unit and a second roller unit in spaced relation to the first cleaning roller unit are provided, wherein the tank device for dirty fluid is positioned between the first cleaning roller unit and the second roller unit.

11. The surface cleaning machine in accordance with claim 10, wherein the second roller unit is a second cleaning roller unit or is a sweeping roller unit.

12. The surface cleaning machine in accordance with claim 10, wherein a cover wall is provided which is connected to the cleaning head and which covers the tank device for dirty fluid.

13. The surface cleaning machine in accordance with claim 12, wherein electrodes of the probe device are arranged at the cover wall.

14. The surface cleaning machine in accordance with claim 12, wherein electrodes of the probe device project, in a direction transverse to a plane, from the cover wall into a receiving space of the tank device for dirty fluid, wherein a first axis of rotation of the first rotary roller unit and a second roller axis of the second roller unit lie in this plane.

15. The surface cleaning machine in accordance with claim 1, wherein the tank device for dirty fluid is releasably arranged at a holding rod device at which the cleaning head is arranged.

16. The surface cleaning machine in accordance with claim 1, wherein the surface cleaning machine is configured as a self-propelled and self-steering apparatus.

17. The surface cleaning machine in accordance with claim 1, wherein the surface cleaning machine is configured as a hand-guided apparatus.

18. The surface cleaning machine in accordance with claim 1, wherein a wetting device is provided by which at least one of the at least one cleaning roller unit and a surface to be cleaned are capable of having cleaning liquid applied thereto, wherein the wetting device comprises a tank device for cleaning liquid.

19. The surface cleaning machine in accordance with claim 18, wherein a flow-through region for cleaning liquid is provided through which cleaning liquid which is provided by the tank device for cleaning liquid flows when it is fed to at least one of the at least one cleaning roller unit and to a surface to be cleaned, and wherein arranged at the flow-through region is a sensor device which determines the presence of cleaning liquid in the flow-through region.

20. The surface cleaning machine in accordance with claim 19, wherein the flow-through region is formed at a tube portion or a hose portion.

21. The surface cleaning machine in accordance with claim 19, wherein, under the normally intended conditions of use of the surface cleaning machine, the flow-through region is arranged, relative to the direction of gravity, below the tank device for cleaning liquid.

22. The surface cleaning machine in accordance with claim 19, wherein, relative to a flow direction of cleaning liquid, the flow-through region is arranged downstream of a port for the tank device for cleaning liquid.

23. The surface cleaning machine in accordance with claim 19, wherein a holder is provided at which the tank device for cleaning liquid is releasably held in place.

24. The surface cleaning machine in accordance with claim 23, wherein a port for the tank device for cleaning liquid is arranged at the holder.

25. The surface cleaning machine in accordance with claim 23, wherein the flow-through region is arranged at the holder.

26. The surface cleaning machine in accordance with claim 19, wherein at least one of the following conditions is satisfied: (i) a capability of a flow-through region to have liquid flowing therethrough is coupled to a rotary drive of the at least one cleaning roller unit, and (ii) the flow-through region is located upstream of a valve device for transferring cleaning liquid to at least one of the at least one cleaning roller unit and the surface to be cleaned.

27. The surface cleaning machine in accordance with claim 19, wherein the sensor device is configured as a resistance measuring device.

28. The surface cleaning machine in accordance with claim 19, wherein the sensor device is configured as an electrode device.

29. The surface cleaning machine in accordance with claim 28, wherein provision is made for a direct current or a direct voltage to be applied to the electrode device.

30. The surface cleaning machine in accordance with claim 28, wherein the sensor device comprises a first electrode and a second electrode in spaced relation to the first electrode, wherein the first electrode and the second electrode project into the flow-through region.

31. The surface cleaning machine in accordance with claim 29, wherein the first electrode and the second electrode are located in a wall of the flow-through region.

32. The surface cleaning machine in accordance with claim 29, wherein at least one of the first electrode and the second electrode are formed as metal pins.

33. The surface cleaning machine in accordance with claim 19, wherein it is determinable via the sensor device whether the tank device for cleaning liquid is empty, the emptying of the tank device for cleaning liquid being inferred from the absence of cleaning liquid in the flow-through region.

34. The surface cleaning machine in accordance with claim 19, wherein the sensor device is operatively connected to an evaluation device for signal communication therewith, wherein at least one of the following conditions is satisfied:
the evaluation device determines a degree of fill of the tank device for cleaning liquid from sensor data of the sensor device;
the evaluation device controls the sensor device;
the evaluation device is operatively connected to at least one of an indication device and a transmitter, for signal communication therewith;
the evaluation device initiates a warning signal when the tank device for cleaning liquid is detected as being empty;
the evaluation device turns off a rotary drive for the at least one cleaning roller unit when the tank device for cleaning liquid is detected as being empty.

35. The surface cleaning machine in accordance with claim 34, wherein the indication device is at least one of (i) arranged at a hand grip via which the cleaning head is guidable by a user, and (ii) arranged at the cleaning head.
